(19) United States
(12) Patent Application Publication
(10) Pub. No.: US 2025/0223190 A1
(43) Pub. Date: Jul. 10, 2025

(54) CATHODE ACTIVE MATERIAL AND METHOD FOR PRODUCING CATHODE ACTIVE MATERIAL

(71) Applicant: TOYOTA JIDOSHA KABUSHIKI KAISHA, Toyota-shi (JP)

(72) Inventors: Ryosuke OHSAWA, Okazaki-shi (JP); Momoko Procter, Seto-shi (JP)

(73) Assignee: TOYOTA JIDOSHA KABUSHIKI KAISHA, Toyota-shi (JP)

(21) Appl. No.: 18/905,419

(22) Filed: Oct. 3, 2024

(30) Foreign Application Priority Data
Jan. 9, 2024 (JP) 2024-001453

(51) Int. Cl. C01G 53/00

(52) U.S. Cl. CPC C01G 53/50; C01P 2004/03; C01P 2006/40

(57) ABSTRACT

A cathode active material includes a composition represented by LiₓNiₐCo_{b}Mn_{c}O_{y}, includes a compound A containing La and Ni and a compound B containing Li and W on a surface of a primary particle, and contains La and W inside the primary particle. In the composition, 0.1≤x≤1.5, 0.5≤a≤1.0, 0≤b≤0.3, 0≤c≤0.3, a+b+c=1.0, and 1.5≤y≤2.1.

### CROSS-REFERENCE TO RELATED APPLICATION

This application claims priority to Japanese Patent Application No. 2024-001453 filed on Jan. 9, 2024, incorporated herein by reference in its entirety.

### BACKGROUND

### 1. Technical Field

The present disclosure relates to a cathode active material and a method for producing a cathode active material.

### 2. Description of Related Art

Hitherto, attempt has been made on a method for controlling crystals of particles in a cathode active material to be used in a battery. For example, Japanese Unexamined Patent Application Publication No. 2023-36570 (JP 2023-36570 A) discloses a method for producing a large crystal grain aggregate ternary cathode material. The production method includes a step of preparing a nickel salt, a cobalt salt, and a manganese salt as a mixed solution. A precipitant and a coordinating agent are added to the mixed solution to adjust pH of the mixed solution to a value from 10.5 to 12 and cause precipitation to obtain a precursor A. The method includes a step of mixing the washed precursor A and a lithium salt in a ball mill to obtain a precursor B, and a step of sintering the precursor B in an air or oxygen atmosphere. This sintering includes constant temperature sintering for 1 h to 6 h at a rate of 5° C./min to 15° C./min and at an increased temperature of 400° C. to 800° C., and constant temperature sintering for 8 h to 10 h at a rate of 1° C./min to 10° C./min and at an increased temperature of 900° C. to 980° C. The method includes a step of obtaining a large crystal grain aggregate ternary cathode material by cooling.

### SUMMARY

Batteries are required to have low resistance, but a battery including a cathode including a cathode active material may have high resistance due to the cathode active material.

The present disclosure has been made in view of the above circumstances, and an object thereof is to provide a cathode active material capable of reducing the resistance of a battery when used in the battery, and a method for producing the cathode active material.

Means for addressing the above issue includes the following aspects.

<1> A cathode active material has a composition represented by LiₓNiₐCo_{b}Mn_{c}O_{y}, includes a compound A containing La and Ni and a compound B containing Li and W on a surface of a primary particle, and contains La and W inside the primary particle.

In the composition, 0.1≤x≤1.5, 0.5≤a≤1.0, 0≤b≤0.3, 0≤c≤0.3, a+b+c=1.0, and 1.5≤y≤2.1.

<2> In the cathode active material according to <1>, the compound A may be a particulate compound, and the compound B may be a laminar compound.

<3> In the cathode active material according to <1> or <2>, the compound A may contain at least either of La₄LiNiO₈ and LaNiO₃, and the compound B may contain Li₆WO₆.

<4> A method for producing a cathode active material includes:
mixing a raw material containing Ni, Co, and Mn, a raw material containing Li, a raw material containing La, and a raw material containing W to obtain a mixture;
subjecting the mixture to high-temperature firing treatment for firing at a temperature of 600° C. or higher and 1000° C. or lower, low-temperature firing treatment for firing at a temperature of 400° C. or higher and 600° C. or lower, and medium-temperature firing treatment for firing a temperature of 500° C. or higher and 800° C. or lower, the temperature being lower than the temperature in the high-temperature firing treatment and higher than the temperature in the low-temperature firing treatment, in an order of the high-temperature firing treatment, the low-temperature firing treatment, and the medium-temperature firing treatment; and
producing a cathode active material including a composition represented by LiₓNiₐCO_{b}Mn_{c}O_{y}, including a compound A containing La and Ni and a compound B containing Li and W on a surface of a primary particle, and containing La and W inside the primary particle.
In the composition, 0.1≤x≤1.5, 0.5≤a≤1.0, 0≤b≤0.3, 0≤c≤0.3, a+b+c=1.0, and 1.5≤y≤2.1.

The present disclosure provides the cathode active material capable of reducing the resistance of a battery when used in the battery, and the method for producing the cathode active material.

### DETAILED DESCRIPTION OF EMBODIMENTS

### Cathode Active Material

The cathode active material according to an embodiment of the present disclosure has a composition represented by LiₓNiₐCo_{b}Mn_{c}O_{y}, and includes compound A containing La and Ni, and Compound B including Li and W on the surface of the primary particle, and includes La and W inside the primary particle. In the composition, 0.1≤x≤1.5, 0.5≤a≤1.0, 0≤b≤0.3, 0≤c≤0.3, a+b+c=1.0, and 1.5≤y≤2.1.

According to the cathode active material of the embodiment of the present disclosure, resistance in a battery can be reduced. The reason why this effect is achieved is presumed as follows.

One of the required performance of a battery is low resistance. However, in a battery including a positive electrode including a cathode active material, resistance sometimes increases due to the cathode active material. Therefore, it is required to reduce the resistance of the cathode active material, thereby reducing the resistance of the battery.

A cathode active material according to an embodiment of the present disclosure includes a compound A containing La and Ni, and a compound B containing Li and W, and La and W inside the primary particles. That is, the compound A having high electronic conductivity and the compound B having high Li conductivity are included on the surface of the particles, and La and W are further included in the particles, so that the resistivity of the surface and the inside of the particles is reduced. As described above, by reducing the resistance of the cathode active material particles on the surface and inside, it is possible to reduce the resistance of the battery by using the cathode active material in the battery.

Next, the cathode active material according to the embodiment of the present disclosure will be described in detail.

A cathode active material according to an embodiment of the present disclosure includes Li, Ni, and O, and may include at least Co and Mn, and the ratio of these components is expressed by LiₓNiₐCo_{b}Mn_{c}O₂. The cathode active material contains La and W as additive elements.

The cathode active material has a compound A containing La and Ni and a compound B containing Li and W on the surface of the particles (primary particles). In addition, La and W are contained inside the grains. The cathode active material may further contain other additive elements.

### Compound A

The cathode active material has a compound A containing La and Ni on the surface of the particles (primary particles). Compound A containing La and Ni includes an oxide containing La and Ni, and preferably contains at least one of La₄LiNiO₈, and LaNiO₃. The compound A is preferably a granular compound, that is, the cathode active material is preferably adhered to the surface of the particles with the granular compound A.

### Compound B

The cathode active material has a compound B containing Li and W on the surface of the particles (primary particles). Compound B containing Li and W includes an oxide containing Li and W, and preferably contains, for example, Li₆WO₆.

Compound B is preferably a laminar (layered) compound, i.e., the cathode active material is at least a portion of the surface of the particles are preferably covered with a laminar (layered) compound B.

### Interior of the Particle

The cathode active material includes La and W inside the particles (primary particles).

As described above, the cathode active material includes the compound A containing La and Ni and the compound B containing Li and W, and includes La and W inside the particles. In other words, La and Ni having high electronic conductivity, and Li and W having high Li conductivity are disposed on the surface of the particle, and La and W are also included in the particle, so that the resistivity of the surface and the inside of the particle is reduced.

Here, the confirmation method of each compound and each element in the particle surface and the particle interior will be described.

In order to confirm compound A and compound B, a cross section of the cathode active material layers is observed by a scanning electron microscope (SEM) and an electron probe microanalyzer (EPMA). Thus, the presence of Compound A, containing La and Ni, and the presence of Compound B, containing Li and W, can be confirmed. In addition, in the present disclosure, the inside of the particles (primary particles) is defined by SEM images of the cross section of the cathode active material layers, and is set to be within 50% from the contour to the inside. La and W inside the particles are checked by scanning electron microscope (SEM) and electron probe microanalyzer (EPMA) on the cross section of the cathode active material layers with respect to the inside of the particles (that is, within 50% from the outline of the primary particles). Thus, the presence of La and W can be confirmed.

The cathode active material includes a compound A containing La and Ni and a compound B containing Li and W, and La and W are contained in the particles. For example, it can be controlled by the following method. In the firing step in producing the cathode active material, firing at a high temperature is performed, and then firing at a low temperature and a medium temperature is performed stepwise. Specifically, it is preferable that the high-temperature firing treatment, the low-temperature firing treatment, and the intermediate-temperature firing treatment are performed in this order. In the high-20 temperature firing treatment, firing is performed at a temperature of 600° C. or higher and 1000° C. or lower. In the low-temperature firing treatment, firing is performed at a temperature of 400° C. or higher and 600° C. or lower. The intermediate-temperature firing treatment is performed at a temperature lower than the temperature in the temperature 500° C. or higher and 800° C. or lower and the high-temperature firing treatment and higher than the temperature in the low-temperature firing treatment. By the first high-temperature firing treatment, the compound A and the compound B are formed on the surface of the particles of the cathode active material, and then, by the low-temperature firing treatment and the intermediate-temperature firing treatment, the elements of La and W enter the inside of the particles of the cathode active material. Thus, the cathode active material according to the embodiment of the present disclosure having the above-described configuration can be obtained.

### Composition

A cathode active material according to an embodiment of the present disclosure includes Li, Ni, and O, and may include at least Co and Mn, and the ratio of these components is expressed by LiₓNiₐCo_{b}Mn_{c}O₂. The cathode active material contains La and W as additive elements. The cathode active material may further contain other additive elements.

In the composition, 0.1≤x≤1.5, 0.5≤a≤1.0, 0≤b≤0.3, 0≤c≤0.3, a+b+c=1.0, and 1.5≤y≤2.1.

In the cathode active material, the ratio x of Li is 0.1 or more and 1.5 or less, preferably 0.3 or more and 1.4 or less, and more preferably 0.5 or more and 1.2 or less, from the viewpoint of reducing the resistivity of the battery or the like. The ratio a of Ni is 0.5 or more and 1.0 or less, preferably 0.6 or more and 0.9 or less, and more preferably 0.7 or more and 0.8 or less, from the viewpoint of reduction of resistivity in the cell or the like. The ratio b of Co is 0 or more and 0.3 or less, preferably 0 or more and 0.2 or less, and more preferably 0.1 or more and 0.2 or less, from the viewpoint of reduction of resistivity in the cell or the like. The ratio c of Mn is 0 or more and 0.3 or less, preferably 0 or more and 0.2 or less, and more preferably 0.1 or more and 0.2 or less, from the viewpoint of reduction of resistivity in the cell or the like. The sum (a+b+c) of the ratios of Ni, Co and Mn is 1.0.

In the cathode active material, the content ratio (mass %) of La contained as an additive element is 0.0005 or more and 0.05 or less, preferably 0.001 or more and 0.040 or less, and more preferably 0.003 or more and 0.030 or less, from the viewpoint of reduction of resistivity in a cell or the like. In the cathode active material, the content ratio (mass %) of W contained as an additive element is 0.0005 or more and 0.05 or less, preferably 0.001 or more and 0.040 or less, and more preferably 0.003 or more and 0.030 or less from the viewpoint of reduction of resistance in a battery or the like. Note that La and W refer to the total amount of the compound A and the compound B contained in the particles of the cathode active material and the total amount of both the compounds contained in the particles.

### A Method for Producing a Cathode Active Material

Next, a method for producing a cathode active material according to an embodiment of the present disclosure will be described. Note that the cathode active material according to the embodiment of the present disclosure described above can be manufactured by the method for manufacturing a cathode active material according to the embodiment of the present disclosure described below.

A method for producing a cathode active material according to an embodiment of the present disclosure includes: a step of mixing a raw material containing a raw material containing Ni, Co and Mn, a raw material containing Li, a raw material containing La, and a raw material containing W to obtain a mixture; and a step of performing a high-temperature firing treatment for firing the mixture at a temperature of 600° C. or higher and 1000° C. or lower, a low-temperature firing treatment for firing at a temperature of 400° C. or higher and 600° C. or lower, and a middle-temperature firing treatment for firing at a temperature lower than a temperature of 500° C. or higher and 800° C. or lower and lower than a temperature of the high-temperature firing treatment and higher than a temperature of the low-temperature firing treatment, in this order. Then, a cathode active material including a composition represented by LiₓNiₐCo_{b}Mn_{c}O_{y}, and having Compound A containing La and Ni, and Compound B containing Li and W on the surface of the primary particles and containing La and W inside the primary particles is produced.

In the composition, 0.1≤x≤1.5, 0.5≤a≤1.0, 0≤b≤0.3, 0≤c≤0.3, a+b+c=1.0, and 1.5≤y≤2.1.

By the first high-temperature firing treatment, the compound A and the compound B are formed on the surface of the particles of the cathode active material, and then, by the low-temperature firing treatment and the intermediate-temperature firing treatment, the elements of La and W enter the inside of the particles of the cathode active material. Thus, the cathode active material according to the embodiment of the present disclosure having the above-described configuration can be obtained.

It is preferable that the method for producing a cathode active material according to the embodiment of the present disclosure includes the following steps (1) to (5).
(1) A step of preparing a solution in which a raw material containing Ni, Co and Mn is dissolved (raw material dissolving step)
(2) A step of adding the solution to an alkaline solution and precipitating a hydroxide (crystallization step)
(3) Step of collecting a precipitate from the alkaline solution
(4) A step of mixing the precipitate with a raw material containing Li, a raw material containing La, and a raw material containing W to obtain a mixture (mixing step)
(5) Baking the mixture (baking step)

Hereinafter, each step will be described in detail.

### (1) Step of Preparing Solutions in Which Raw Materials Containing Ni, Co, and Mn, Respectively

Solutions obtained by dissolving a raw material containing Ni, a raw material containing Co, and a raw material containing Mn are prepared.

For example, a solution can be prepared by dissolving a raw material containing Ni, a raw material containing Co, and a raw material containing Mn in a solvent such as water. The concentration of the solution is preferably in the range of, for example, 10 to 40% by mass. The ratio of Ni/Co/Mn, relative to Ni: 1.0, it is preferable to the ratio of 1.0/0.8 to 1.2/0.8 to 1.2 (atm %).

Examples of the raw material containing Ni include a sulfate such as NiSO₄; examples of the raw material containing Co include a sulfate such as CoSO₄; and examples of the raw material containing Mn include a sulfate such as MnSO₄.

### (2) Step of Adding a Solution to the Alkaline Solution and Precipitating the Hydroxide

The solution is then added to the alkaline solution to precipitate the hydroxide. As a result, the particles in which the hydroxide containing Ni, Co and Mn is formed are crystallized, and the particles are obtained as a precipitate. In this step, the transition-metal hydroxide is precipitated by, for example, dropping the solution and NH₃ while controlling the alkaline solution in which the hydroxide is precipitated to a certain pH (e.g., pH10 to 12).

### (3) Step of Collecting the Precipitate From the Alkaline Solution

The precipitate is then collected from the alkaline solution. Examples of the method for collecting particles of the precipitate include filtration and washing with water. First, the precipitate (particles) is taken out by filtration, washed with water, and then the washed liquid is filtered to take out the precipitate (particles). The precipitate (particles) after washing with water may be further dried.

### (4) Step of Mixing the Precipitate With a Raw Material Containing Li, a Raw Material Containing La, and a Raw Material Containing W to Obtain a Mixture

Then, the collected precipitate (particulates) is mixed with a raw material containing Li, a raw material containing La, and a raw material containing W to obtain a mixed product. When the cathode active material further contains another additive element, a raw material containing the additive element may be added.

Examples of the mixing method include a method in which grains of the collected precipitate, a raw material containing Li, a raw material containing La, and a raw material containing W are mixed in a mortar.

Examples of the raw material containing Li include Li₂CO₃, and LiOH. Examples of the raw material containing La include La₂O₃. Examples of the raw material containing W include W₂O₃.

### (5) Step of Calcining the Mixture

Next, a mixture of the collected precipitate (grains) and a raw material containing Li, a raw material containing La, and a raw material containing W is calcined. For example, the mixture can be calcined by a calcination furnace (such as a muffle furnace).

In the method for producing a cathode active material according to the embodiment of the present disclosure, each of the firing processes shown in the following (a) to (c) is performed in this order.
(a) High-temperature firing treatment for firing at a temperature of 600° C. or higher and 1000° C. or lower
(b) Low-temperature firing treatment for firing at a temperature of 400° C. or higher and 600° C. or lower
(c) Medium-temperature firing treatment which fires at a temperature higher than the temperature in low-temperature firing treatment lower than the temperature in temperature 500° C. or more and 800° C. or less and high-temperature firing treatment

(a) The temperature in the high-temperature firing treatment is 600° C. or more and 1000° C. or less, and is preferably 550° C. or more and 750° C. or less, and more preferably 600° C. or more and 700° C. or less from the viewpoint of reduction of resistance in the battery or the like. (a) The heating time at the temperature in the high-temperature firing treatment is preferably 1 hour or more and 5 hours or less, and more preferably 2 hours or more and 4 hours or less from the viewpoint of reduction of resistance in the battery. (b) The temperature in the low-temperature firing treatment is 400° C. or more and 600° C. or less, and from the viewpoint of reduction in resistance in the battery or the like, it is preferably 420° C. or more and 580° C. or less, and more preferably 450° C. or more and 550° C. or less.

(b) The heating time at the temperature in the low-temperature firing treatment is preferably 1 hour or more and 5 hours or less, and more preferably 2 hours or more and 4 hours or less from the viewpoint of reduction of resistance in the battery.

(c) The temperature in the medium-temperature firing treatment is 500° C. or more and 800° C. or less, and from the viewpoint of reduction of resistance in the battery or the like, it is preferably 550° C. or more and 750° C. or less, and more preferably 600° C. or more and 700° C. or less. (c) The heating time at the temperature in the medium-temperature firing treatment is preferably 1 hour or more and 5 hours or less, and more preferably 2 hours or more and 4 hours or less from the viewpoint of reduction of resistance in the battery.

The calcination is preferably carried out under an oxygen atmosphere. In order to set the cathode active material to a predetermined particle diameter, the mixture after firing may be subjected to crushing. Examples of the method of crushing include a method of pulverizing by a pulverizer (for example, a jet mill).

Through these steps, the cathode active material according to the embodiment of the present disclosure can be obtained.

### Battery

The cathode active material according to the embodiment of the present disclosure can be used in a battery, and is particularly preferably used in a lithium ion battery. The battery includes, for example, a negative electrode, a positive electrode, a separator, and an electrolyte.

The battery according to the embodiment of the present disclosure may be a solid battery having a solid electrolyte or a liquid battery having a liquid electrolyte, but is preferably a liquid battery. In addition, a bipolar battery including a cathode active material layer and a negative electrode active material layer on both surfaces of a current collector having functions of a positive electrode current collector and a negative electrode current collector may be used. The positive electrode includes, for example, a positive electrode current collector and a cathode active material layer fixed on the positive electrode current collector. The negative electrode includes, for example, a negative electrode current collector and a negative electrode active material layer fixed on the negative electrode current collector. The separator is an electrically insulating porous film. The separator electrically isolates the positive electrode and the negative electrode. The battery according to the embodiment of the present disclosure may further be a liquid-based battery having an electrolytic solution. In particular, a non-aqueous electrolyte solution is preferable.

Applications of batteries include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Example 1

### Synthetic Raw Material Dissolving Solution of Cathode Active Material

NiSO₄, CoSO₄, and MnSO₄ were dissolved in ion-exchanged water to obtain a raw material solution. The ratio of Ni/Co/Mn was 1/1/1 (atm %) and the aqueous solution was 30 wt %.

### Crystallization

A fixed volume of NH₃ aqueous solution was placed in the reactor and nitrogen-substituted with stirrer. NaOH was added to the reactor to make pH alkaline. Then, the raw material solution and NH₃ were added dropwise while controlling the inside of the reactor from a constant pH (pH10 to 12), and the transition-metal hydroxide was precipitated.

Washing with Water, Filtration, Drying

The precipitated transition metal hydroxide was removed by filtration, and ion-exchanged water was added thereto, and the mixture was stirred and dispersed by a spoon, and washed with water. The washed solution was then filtered to remove the transition metal hydroxide. The filtered transition metal hydroxide was then dried at 120° C. for 16 hours and the water evaporated.

### Mixing of Raw Materials of Li and Additive Elements

The dried transition-metal hydroxide, Li₂CO₃ and LiOH as Li raw materials, and La₂O₃ and W₂O₃ as raw materials of additive elements were mixed in a mortar. The quantity of La added by of La₂O₃ was adjusted to a ratio at which La₄LiNiO₈ was generated on the surface of the grains of the cathode active material.

### Calcination and Crushing

Mixtures of transition-metal hydroxides with Li raw materials and with raw materials of additive elements were calcined in a calcination furnace (muffle furnace). Incidentally, this firing, a high-temperature firing treatment at 900° C., a low-temperature firing treatment at 500° C., and a medium-temperature firing treatment at 700° C., each performed for 3 hours in this order in an oxygen atmosphere, a step firing process.

Then, the mixture after calcination was pulverized by a pulverizer (jet mill) to crush to a predetermined particle size. Thus, the cathode active material of Example 1 was obtained.

The cathode active material of Example 1 contained Li, Ni, Co, Mn, O, La, and W, and the ratio (mass ratio) of Li, Ni, Co, Mn, and O was the ratio shown in Table 1. With respect to the obtained cathode active material, it was confirmed by the above-described confirmation method that the granular compound A having the composition shown in Table 1 and the laminar (layered) compound B having the composition shown in Table 1 had on the surface of the primary particles. The cathode active material obtained was confirmed to contain La and W inside the primary grains by the above-described confirmation methods.

### Example 2

In Example 1, La₂O₃ was adjusted to a ratio at which LaNiO₃ were formed on the grains of the cathode active material, and the cathode active material of each Example was obtained in the same manner as in Example 1.

The cathode active material of Example 2 contained Li, Ni, Co, Mn, O, La, and W, and the ratio (mass ratio) of Li, Ni, Co, Mn, and O was the ratio shown in Table 1. With respect to the obtained cathode active material, it was confirmed by the above-described confirmation method that the granular compound A having the composition shown in Table 1 and the laminar (layered) compound B having the composition shown in Table 1 had on the surface of the primary particles. The cathode active material obtained was confirmed to contain La and W inside the primary grains by the above-described confirmation methods.

### Comparative Example 1

In Example 1, La₂O₃ and W₂O₃ as a raw material of the additive element were not added, except that the firing condition was changed to a condition of firing at 900° C. for 10 hours in an oxygen atmosphere, and the cathode active material of Comparative Example 1 was obtained in the same manner as in Example 1.

The cathode active material of Comparative Example 1 contained Li, Ni, Co, Mn, and O, and the ratio (mass ratio) of Li, Ni, Co, Mn, and O was the ratio shown in Table 1.

For the obtained cathode active material, Compound A and Compound B are present on the surface of the primary particles, and Comparative Example 2

Neither La nor W was present inside the primary grains.

In Example 1, except that only La₂O₃ as a raw material of the additive element was added, and the firing condition was changed to the condition of firing at 900° C. for 10 hours in an oxygen atmosphere, a cathode active material of Comparative Example 2 was obtained in the same manner as in Example 1.

The cathode active material of Comparative Example 2 contained Li, Ni, Co, Mn, O, and La, and the ratio (mass ratio) of Li, Ni, Co, Mn, and O was the ratio shown in Table 1. The obtained cathode active material was confirmed to have the granular compound A having the composition shown in Table 1 on the surface of the primary particles by the above-described confirmation method. In addition, La and W were not present inside the primary grains.

### Comparative Example 3

In Example 1, except that only W₂O₃ as a raw material of the additive element was added, and the firing condition was changed to the condition of firing at a temperature of 900° C. for 10 hours in an oxygen atmosphere, a cathode active material of Comparative Example 3 was obtained in the same manner as in Example 1.

The cathode active material of Comparative Example 3 contained Li, Ni, Co, Mn, O, and W, and the ratios (mass ratios) of Li, Ni, Co, Mn, and O were the ratios shown in Table 1. The obtained cathode active material was confirmed to have the laminar (layered) compound B having the composition shown in Table 1 on the surface of the primary particles by the above-described confirmation method. In addition, La and W were not present inside the primary grains. Comparative Example 4

In Example 1, a cathode active material of Comparative Example 4 was obtained in the same manner as in Example 1, except that the firing conditions were changed to conditions for firing under an oxygen atmosphere at a temperature of 900° C. for 10 hours.

The cathode active material of Comparative Example 4 contained Li, Ni, Co, Mn, O, La, and W, and the ratios (mass ratios) of Li, Ni, Co, Mn, and O were the ratios shown in Table 1. With respect to the obtained cathode active material, it was confirmed by the above-described confirmation method that the granular compound A having the composition shown in Table 1 and the laminar (layered) compound B having the composition shown in Table 1 had on the surface of the primary particles. In addition, La and W were not present inside the primary grains.

### Comparative Example 5

In Example 1, the cathode active material of Comparative Example 5 was obtained in the same manner as in Example 1, except that only La₂O₃ as a raw material of the additive element was added.

The cathode active material of Comparative Example 5 contained Li, Ni, Co, Mn, O, and La, and the ratio (mass ratio) of Li, Ni, Co, Mn, and O was the ratio shown in Table 1. The obtained cathode active material was confirmed to have the granular compound A having the composition shown in Table 1 on the surface of the primary particles by the above-described confirmation method. In addition, the cathode active material obtained was confirmed to contain La inside the primary grains by the above-described confirmation methods.

### Comparative Example 6

In Example 2, the cathode active material of Comparative Example 6 was obtained in the same manner as in Example 2, except that only La₂O₃ as a raw material of the additive element was added.

The cathode active material of Comparative Example 6 contained Li, Ni, Co, Mn, O, and La, and the ratio (mass ratio) of Li, Ni, Co, Mn, and O was the ratio shown in Table 1. The obtained cathode active material was confirmed to have the granular compound A having the composition shown in Table 1 on the surface of the primary particles by the above-described confirmation method. In addition, the cathode active material obtained was confirmed to contain La inside the primary grains by the above-described confirmation methods.

### Comparative Example 7

In Example 1, the cathode active material of Comparative Example 7 was obtained in the same manner as in Example 1, except that only W₂O₃ as a raw material of the additive element was added.

The cathode active material of Comparative Example 7 contained Li, Ni, Co, Mn, O, and W, and the ratios (mass ratios) of Li, Ni, Co, Mn, and O were the ratios shown in Table 1. The obtained cathode active material was confirmed to have the laminar (layered) compound B having the composition shown in Table 1 on the surface of the primary particles by the above-described confirmation method. In addition, the obtained cathode active material was confirmed to contain W inside the primary particles by the above-described confirmation method.

### Cell Fabrication

Cells were prepared using the cathode active materials obtained in Examples and Comparative Examples.

### Cell Configuration

Wound cylinder
Positive electrode composition: cathode active material/acetylene black (conductive material)/polyvinylidene fluoride=88/10/2 (mass %)
Negative electrode composition: Natural graphite/styrene butadiene rubber (SBR)/carboxymethylcellulose (CMC)
Electrolyte composition: electrolyte=LiPF₆ (1M), solvent=ethylene carbonate (EC)/dimethyl carbonate (DMC)/ethyl methyl carbonate (EMC)=3/4/3 (vol %)

### Fabrication of Electrodes

A film applicator with a film thickness adjusting function (All Good Co., Ltd.) was used to coat a positive electrode and a negative electrode on a current collector, and dried in a dryer at 80° C. for 5 minutes to prepare a cell. Initial Resistance

The initial battery resistance was measured for the cells obtained in the Examples and Comparative Examples. Table 1 shows the results of the ratio (%) of the battery resistances of the respective examples and comparative examples when the battery resistance of Comparative Example 1 is “100%”.

The “ratio” of the compound A shown in Table 1 means the ratio of the total amount of La contained in the cathode active material, and the “ratio” of the compound B means the ratio of the total amount of W contained in the cathode active material.

Incidentally, the “synthesis method 2” shown in Table 1, the temperature 600° C. or higher 1000° C. or less and a high-temperature firing treatment for firing at a temperature higher than the temperature in the intermediate temperature firing treatment, the low-temperature firing treatment for firing at a temperature 400° C. or higher 600° C. or less, and the temperature 500° C. or higher 800° C. or less and the intermediate temperature firing treatment for firing at a temperature higher than the temperature in the low-temperature firing treatment, a synthesis method having a step firing step performed in this order. On the other hand, the “synthesis method 1” means a synthesis method that does not have the above-described step firing step.

TABLE 1

| | Li | Ni | Co | Mn | O | | | | | Inside | | Initial |
|---|---|---|---|---|---|---|---|---|---|---|---|---|
| | Ratio | Ratio | Ratio | Ratio | Ratio | Compound A | | Compound B | | the | Synthetic | resistance |
| | x | a | b | c | y | Type | Ratio | Type | Ratio | particle | method | % |
| Comparative | 1.1 | 0.8 | 0.1 | 0.1 | 2.0 | — | — | — | — | — | 1 | 100 |
| example 1 | | | | | | | | | | | | |
| Comparative | 1.1 | 0.8 | 0.1 | 0.1 | 2.0 | La₄LiNiO₈ | 0.01 | — | — | — | 1 | 101 |
| example 2 | | | | | | | | | | | | |
| Comparative | 1.1 | 0.8 | 0.1 | 0.1 | 2.0 | — | — | Li₆WO₆ | 0.01 | — | 1 | 99 |
| example 3 | | | | | | | | | | | | |
| Comparative | 1.1 | 0.8 | 0.1 | 0.1 | 2.0 | La₄LiNiO₈ | 0.01 | Li₆WO₆ | 0.01 | — | 1 | 102 |
| example 4 | | | | | | | | | | | | |
| Comparative | 1.1 | 0.8 | 0.1 | 0.1 | 2.0 | La₄LiNiO₈ | 0.01 | — | — | La | 2 | 103 |
| example 5 | | | | | | | | | | | | |
| Comparative | 1.1 | 0.8 | 0.1 | 0.1 | 2.0 | LaNiO₃ | 0.01 | — | — | La | 2 | 99 |
| example 6 | | | | | | | | | | | | |
| Comparative | 1.1 | 0.8 | 0.1 | 0.1 | 2.0 | — | — | Li₆WO₆ | 0.01 | W | 2 | 105 |
| example 7 | | | | | | | | | | | | |
| Example 1 | 1.1 | 0.8 | 0.1 | 0.1 | 2.0 | La₄LiNiO₈ | 0.01 | Li₆WO₆ | 0.01 | La + | 2 | 75 |
| | | | | | | | | | | W | | |
| Example 2 | 1.1 | 0.8 | 0.1 | 0.1 | 2.0 | LaNiO₃ | 0.01 | Li₆WO₆ | 0.01 | La + | 2 | 76 |
| | | | | | | | | | | W | | |

As shown in Tables 1, Compound A containing La and Ni and Compound B containing Li and W are present on the primary particles. It can be seen that in the cathode active materials of the respective examples containing La and W inside the primary grains, the initial resistance of the batteries can be reduced as compared with the cathode active materials of the respective comparative examples that do not satisfy these requirements.

What is claimed is:

1. A cathode active material comprising a composition represented by LiₓNiₐCo_{b}Mn_{c}O_{y}, including a compound A containing La and Ni and a compound B containing Li and W on a surface of a primary particle, and containing La and W inside the primary particle, wherein in the composition, 0.1≤x≤1.5, 0.5≤a≤1.0, 0≤b≤0.3, 0≤c≤0.3, a+b+c=1.0, and 1.5≤y≤2.1.

2. The cathode active material according to claim 1, wherein the compound A is a particulate compound, and the compound B is a laminar compound.

3. The cathode active material according to claim 1, wherein the compound A contains at least either of La₄LiNiO₈ and LaNiO₃, and the compound B contains Li₆WO₆.

4. A method for producing a cathode active material, the method comprising:
mixing a raw material containing Ni, Co, and Mn, a raw material containing Li, a raw material containing La, and a raw material containing W to obtain a mixture;
subjecting the mixture to high-temperature firing treatment for firing at a temperature of 600° C. or higher and 1000° C. or lower, low-temperature firing treatment for firing at a temperature of 400° C. or higher and 600° C. or lower, and medium-temperature firing treatment for firing a temperature of 500° C. or higher and 800° C. or lower, the temperature being lower than the temperature in the high-temperature firing treatment and higher than the temperature in the low-temperature firing treatment, in an order of the high-temperature firing treatment, the low-temperature firing treatment, and the medium-temperature firing treatment; and
producing a cathode active material including a composition represented by LiₓNiₐCo_{b}Mn_{c}O_{y}, including a compound A containing La and Ni and a compound B containing Li and W on a surface of a primary particle, and containing La and W inside the primary particle, wherein in the composition, 0.1≤x≤1.5, 0.5≤a≤1.0, 0≤b≤0.3, 0≤c≤0.3, a+b+c=1.0, and 1.5≤y≤2.1.
